(19) United States
(12) Patent Application Publication
(10) Pub. No.: US 2026/0039063 A1
(43) Pub. Date: Feb. 5, 2026

(54) SHIELDED TERMINAL

(71) Applicant: SUMITOMO WIRING SYSTEMS, LTD., Mie (JP)

(72) Inventor: Shuhei YAMADA, Mie (JP)

(21) Appl. No.: 19/283,592

(22) Filed: Jul. 29, 2025

(30) Foreign Application Priority Data
Aug. 5, 2024 (JP) 2024-128784

(51) Int. Cl. H01R 13/6592; H01R 13/6581

(52) U.S. Cl. CPC H01R 13/6592; H01R 13/6581

(57) ABSTRACT

A shielded terminal includes an inner conductor, a dielectric, a first outer conductor that receives the dielectric, and a second outer conductor attached to the first outer conductor. The first outer conductor includes a pair of first side walls facing each other in a left-right direction, and an opening formed between upper ends of the pair of first side walls. The second outer conductor includes a cover wall covering the opening from above, a pair of second side walls facing each other in the left-right direction, and a barrel portion coupled to a rear end portion of the cover wall. The barrel portion is connected to a shield portion of a shielded wire by crimping. The pair of first side walls each have a first facing surface facing rearward.

### CROSS-REFERENCE TO RELATED APPLICATIONS

This application is based on and claims priority from Japanese Patent Application No. 2024-128784, filed on Aug. 5, 2024, with the Japan Patent Office, the disclosure of which is incorporated herein in its entirety by reference.

### TECHNICAL FIELD

The present disclosure relates to a shielded terminal.

### BACKGROUND

A shielded electrical connector described in JP H07-254454 A includes an upper back shell and a lower back shell. A rear pushing arm protrudes laterally from a side wall of the upper back shell. A vertical slot is provided in a side wall of the lower back shell. The vertical slot is formed by cutting out a portion of the side wall and is open upward. The rear pushing arm is placed into the vertical slot from above, and the rear pushing arm is locked to an edge of the vertical slot.

JP 2023-151740 A discloses a cover member and a shield member assembled to each other. A barrel portion (not named in JP 2023-151740 A) that is crimped over a rear portion of the shield member and a terminal end portion of a shielded wire is formed in a rear end portion of the cover member. Other technologies relating to a shielded connector are also described in JP 2018-125199 A.

### SUMMARY

In the case of JP H07-254454 A, the vertical slot is formed by cutting out the side wall of the lower back shell, and therefore, there is a concern that shield performance may be impaired.

In the case of JP 2023-151740 A, there is a concern that, when the barrel portion is crimped, a front end portion of the cover member may be displaced in such a manner as to be raised relative to the shield member. Such a concern of displacement may be present in the case of JP 2018-125199 A as well.

Therefore, an object of the present disclosure is to provide a shielded terminal that can maintain shield performance and prevent displacement of an outer conductor.

A shielded terminal according to the present disclosure includes: an inner conductor connected to a front end portion of a shielded wire; a dielectric in which the inner conductor is housed; a first outer conductor that receives the dielectric; and a second outer conductor attached to the first outer conductor, wherein the first outer conductor includes: a pair of first side walls facing each other in a left-right direction; and an opening formed between upper ends of the pair of first side walls, the second outer conductor includes: a cover wall covering the opening from above; a pair of second side walls facing each other in the left-right direction; and a barrel portion coupled to a rear end portion of the cover wall, the barrel portion is connected to a shield portion of the shielded wire by crimping, the pair of first side walls each have a first facing surface facing rearward, and the pair of second side walls protrude downward from the cover wall and each have a second facing surface as a front end surface that faces the first facing surface.

According to the present disclosure, it is possible to provide a shielded terminal that can maintain shield performance and prevent displacement of an outer conductor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a shielded terminal according to Embodiment 1 of the present disclosure.

FIG. 2 is a cross-sectional view of the shielded terminal according to Embodiment 1.

FIG. 3 is a perspective view showing a state in which an inner conductor is connected to a terminal end portion of a shielded wire and the inner conductor is housed in a dielectric in the shielded terminal according to Embodiment 1.

FIG. 4 is a perspective view of a first outer conductor included in the shielded terminal according to Embodiment 1.

FIG. 5 is a perspective view of a second outer conductor included in the shielded terminal according to Embodiment 1.

FIG. 6 is a side view showing a state in a process for attaching the second outer conductor to the first outer conductor in the shielded terminal according to Embodiment 1.

FIG. 7 is a side view showing a state in which the second outer conductor has been attached to the first outer conductor in the shielded terminal according to Embodiment 1.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF THE PRESENT DISCLOSURE

First, aspects of the present disclosure will be listed and described.

(1) A shielded terminal according to the present disclosure includes an inner conductor connected to a front end portion of a shielded wire; a dielectric in which the inner conductor is housed; a first outer conductor that receives the dielectric; and a second outer conductor attached to the first outer conductor, wherein the first outer conductor includes: a pair of first side walls facing each other in a left-right direction; and an opening formed between upper ends of the pair of first side walls, the second outer conductor includes: a cover wall covering the opening from above; a pair of second side walls facing each other in the left-right direction; and a barrel portion coupled to a rear end portion of the cover wall, the barrel portion is connected to a shield portion of the shielded wire by crimping, the pair of first side walls each have a first facing surface facing rearward, and the pair of second side walls protrude downward from the cover wall and each have a second facing surface as a front end surface that faces the first facing surface.

When the barrel portion of the second outer conductor is crimped onto the shield portion of the shielded wire, the above configuration (1) makes it possible to prevent displacement of the second outer conductor from the first outer conductor because the second facing surface comes into contact with the first facing surface and the crimping force is transmitted to the side walls. In particular, the second facing surface is the front end surface of each second side wall, and is not formed by cutting out a large portion of the outer conductor, and therefore, the shield performance can be maintained. Note that the wording “face each other” expresses a concept that encompasses both a case where the first facing surface and the second facing surface face each other with a space therebetween and a case where the first facing surface and the second facing surface facing each other are in contact with each other.

(2) In the shielded terminal described above in (1), it is preferable that the pair of first side walls each have a protrusion protruding outward in the left-right direction, and the first facing surface is a rear end surface of the protrusion.

In the above configuration (2), it is easy to adjust the protruding amount of the protrusion and the position at which the protrusion is formed on the first side wall, and therefore, the degree of freedom of design of the first facing surface is high.

(3) In the shielded terminal described above in (2), it is preferable that the protrusion is located in a lower portion of each of the pair of first side walls.

In the above configuration (3), when the barrel portion of the second outer conductor is crimped onto the shield portion of the shielded wire, the second facing surface comes into contact with the protrusion that is spaced apart from the barrel portion, and therefore, it is possible to effectively prevent a front end portion of the cover wall from being displaced in such a manner as to be raised relative to the first outer conductor.

(4) In the shielded terminal described above in (3), it is preferable that the protrusion includes an upper protrusion located in an upper portion of each of the pair of first side walls, in addition to a lower protrusion located in the lower portion, a rear end surface of the upper protrusion also constitutes the first facing surface that faces the second facing surface, and the first facing surfaces of the upper protrusion and the protrusion are aligned on the same straight line extending along an up-down direction.

In a process for attaching the second outer conductor to the first outer conductor, the above configuration (4) makes it possible to move the second facing surface of the second side wall along the first facing surface of the upper protrusion, and the first facing surface of the upper protrusion can be used as a guide (reference) for determining the position of the front end of the second outer conductor. Therefore, the second outer conductor can be easily attached to the first outer conductor.

(5) In the shielded terminal described above in any of (1) to (4), it is preferable that both the first facing surface and the second facing surface are vertical surfaces extending in an up-down direction.

The above configuration (5) makes it possible to more reliably prevent displacement of the second outer conductor from the first outer conductor when the barrel portion is crimped onto the shielded wire.

### DETAILS OF EMBODIMENT OF THE PRESENT DISCLOSURE

A specific example of an embodiment of the present disclosure will be described below with reference to the drawings. Note that the present invention is not limited to this example, but is defined by the claims, and is intended to encompass all alterations within the meanings and scope that are equivalent to the claims.

### Embodiment 1

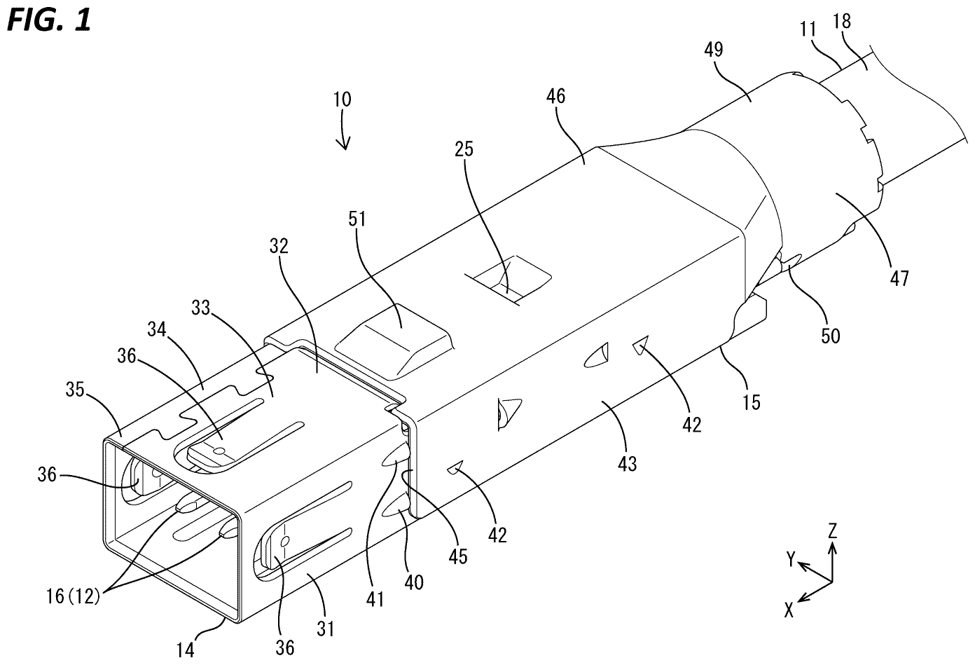

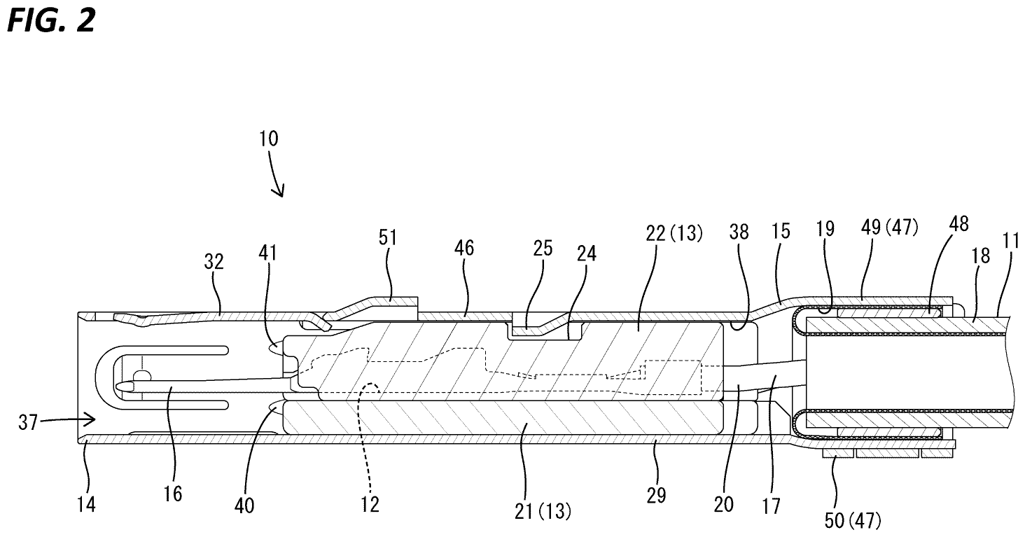

The following describes a specific example of Embodiment 1 of the present disclosure with reference to FIGS. 1 to 7. As shown in FIG. 1, a shielded terminal 10 is connected to a shielded wire 11. As shown in FIG. 2, the shielded terminal 10 includes an inner conductor 12, a dielectric 13, a first outer conductor 14, and a second outer conductor 15. The shielded terminal 10 is housed in a housing (not shown). The shielded terminal 10 and the housing constitute a shielded connector (not shown). Note that the X direction, Y direction, and Z direction in FIG. 1 indicate the forward direction, leftward direction, and upward direction, respectively. In the following description, the up-down direction matches the height direction of the shielded terminal 10. The left-right direction matches the width direction of the shielded terminal 10. Note that these directions do not necessarily match the corresponding directions in a state where the shielded terminal 10 has been installed in a vehicle (not shown) or the like.

### (Inner Conductor 12 and Shielded Wire 11]

The inner conductor 12 is made of a conductive metal and has a shape elongated in the front-rear direction as a whole, although details are not illustrated. As shown in FIG. 1, the inner conductor 12 includes a tab 16 protruding forward. The inner conductor 12 is connected to a core wire (not shown) of the shielded wire 11.

As shown in FIG. 2, the shielded wire 11 includes two coated wires 17 (only one of them is shown in FIG. 2), a sheath 18, and a shield portion 19. Each coated wire 17 is formed by covering an outer circumferential surface of a core wire with an insulating covering 20. The sheath 18 is disposed so as to cover outer circumferential surfaces of the coated wires 17. The shield portion 19 is disposed between the sheath 18 and the coated wires 17. In Embodiment 1, the shield portion 19 is constituted by a braided wire. A front end portion of the shield portion 19 is exposed by peeling off the sheath 18 and is folded back onto a sleeve 48 that is disposed on an outer circumferential surface of the sheath 18. The sleeve 48 is disposed between the folded-back braided wire and the sheath 18 and receives a crimping force of a barrel portion 47 included in the second outer conductor 15, which will be described later. In Embodiment 1, the two coated wires 17 are twisted pair wires. Each coated wire 17 is untwisted at a position at which the coated wire 17 is exposed from a front end portion of the sheath 18. Although not shown in the drawings, in a front end portion of each coated wire 17, the core wire is exposed by peeling off the insulating covering 20. The inner conductor 12 is connected to the exposed core wire. The shielded terminal includes two inner conductors 12 respectively corresponding to the coated wires 17.

### (Dielectric 13)

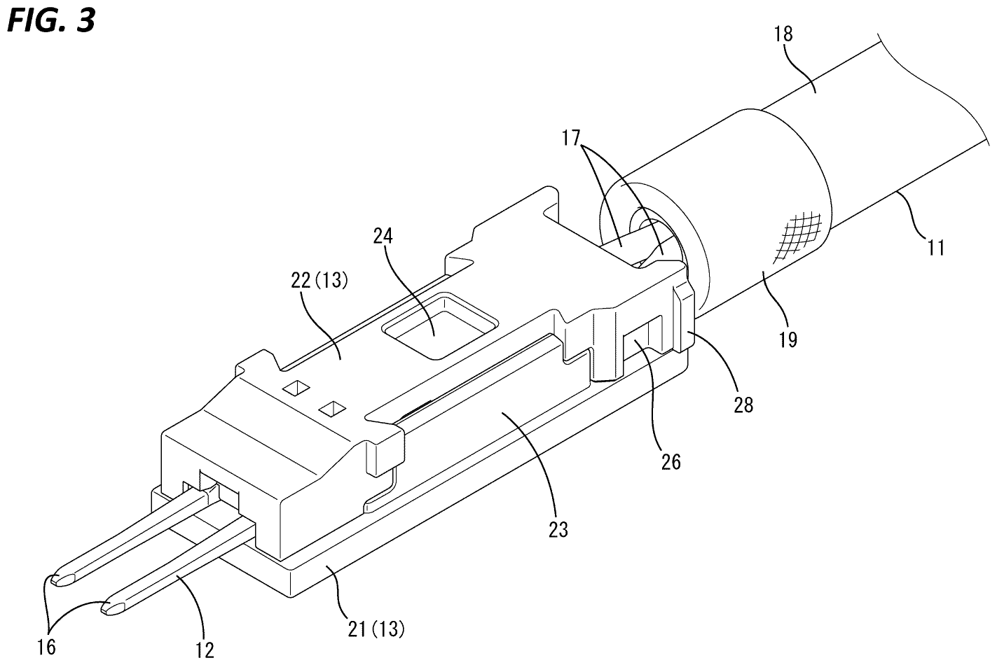

The dielectric 13 is made of a resin having insulating properties. As shown in FIG. 3, the dielectric 13 includes a first dielectric 21 and a second dielectric 22. The second dielectric 22 is disposed above the first dielectric 21. The inner conductors 12 are housed side by side in the left-right direction between the first dielectric 21 and the second dielectric 22. The first dielectric 21 includes a side portion 23 that protrudes upward and to which the second dielectric 22 is locked.

The tabs 16 of the inner conductors 12 protrude in front of the dielectric 13. The coated wires 17 of the shielded wire 11 are disposed behind the dielectric 13. An upper surface lock target portion 24 that has a rectangular shape in a plan view is recessed in an upper surface of the second dielectric 22. As shown in FIG. 2, an upper surface lock portion 25 included in the second outer conductor 15, which will be described later, is fitted to the upper surface lock target portion 24 and locked thereto. As shown in FIG. 3, a lock target portion 26 that has a rectangular shape in a side view is recessed in each of left and right side surfaces of the second dielectric 22. Lock portions 27 of the first outer conductor 14, which will be described later, can be locked to the lock target portions 26 by being fitted thereto.

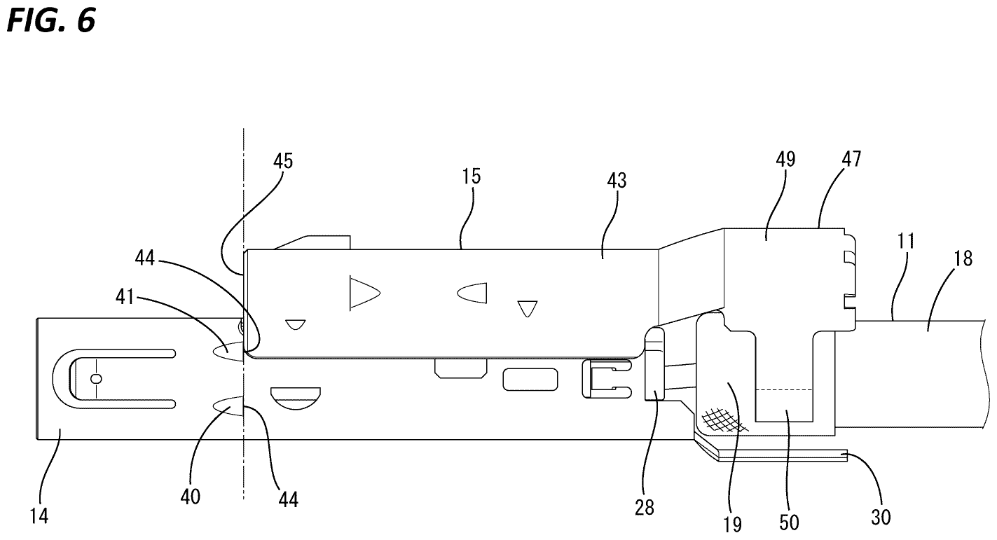

Also, a pair of rib-shaped stopper portions 28 (only one of them is shown in FIG. 3) extending in the up-down direction protrude from the left and right side surfaces of the second dielectric 22. As shown in FIG. 6, the stopper portions 28 can abut against the rear end of the first outer conductor 14.

### (First Outer Conductor 14)

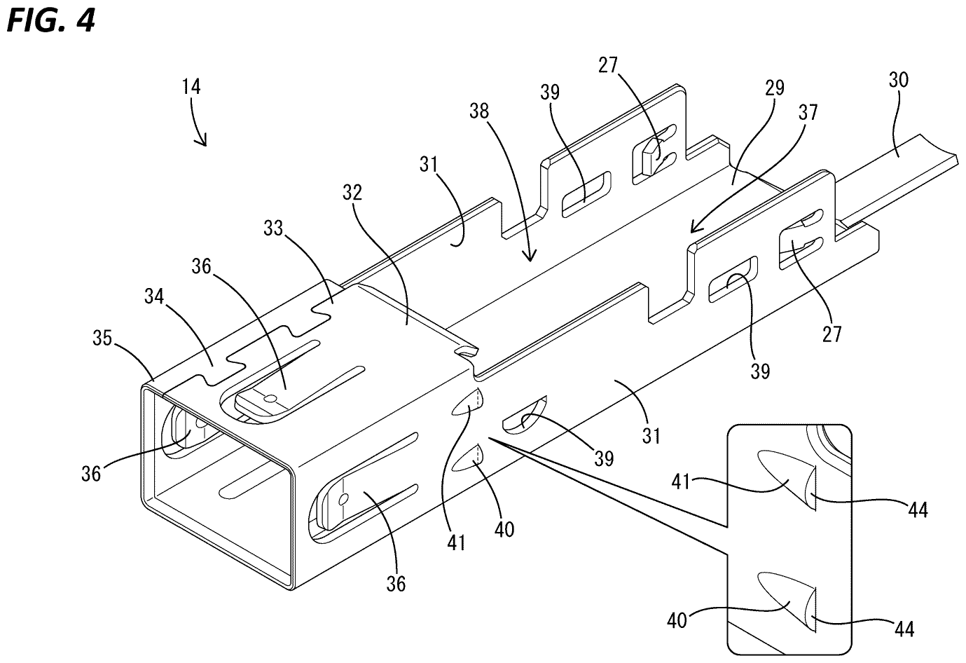

The first outer conductor 14 is made of a conductive metal and is formed by bending a metal plate through pressing or the like. As shown in FIG. 4, the first outer conductor 14 has a bottom wall 29, an extended portion 30, a pair of first side walls 31, and an upper wall 32. The bottom wall 29 has a flat plate shape and extends in the front-rear direction such that plate surfaces face the up-down direction. The extended portion 30 has a band plate shape and extends rearward from a center portion of the rear end of the bottom wall 29 in the left-right direction.

The first side walls 31 stand upright from both end portions of the bottom wall 29 in the left-right direction such that plate surfaces face the left-right direction. The first side walls 31 and the bottom wall 29 have the same length in the front-rear direction.

The upper wall 32 has a flat plate shape, is located above a front portion of the bottom wall 29, and faces the bottom wall 29. The upper wall 32 couples upper ends of front portions of the first side walls 31. The upper wall 32 includes one side portion 33 extending from the upper end of one of the first side walls 31 toward the upper end of the other first side wall 31, and another side portion 34 extending from the upper end of the other first side wall 31 toward the upper end of the one first side wall 31. The one side portion 33 is longer than the other side portion 34 in the left-right direction.

The one side portion 33 and the other side portion 34 are fitted and coupled to each other at a position that is located eccentrically toward one side from the center of the upper wall 32 in the left-right direction. The front portion of the bottom wall 29, the front portions of the first side walls 31, and the upper wall 32 form a tubular portion 35 that has a rectangular tube shape in a front portion of the first outer conductor 14. Elastic contact portions 36 are formed in the one side portion 33 and the first side walls 31 by cutting the one side portion 33 and the first side walls 31 and bending the cut portions inward toward the tubular portion 35. Each elastic contact portion 36 is electrically connected to a counter outer conductor (not shown) that is inserted into the tubular portion 35.

The first outer conductor 14 includes a housing space 37. The housing space 37 is constituted by the inside of the tubular portion 35 and a space behind the tubular portion 35. The dielectric 13 is housed in the housing space 37. An opening 38 is formed between the upper ends of the first side walls 31. The opening 38 is formed in a region between the upper ends of the first side walls 31, excluding the upper wall 32. The opening 38 is longer than the upper wall 32 in the front-rear direction. As shown in FIG. 1, the tabs 16 of the inner conductors 12 protrude to the inside of the tubular portion 35.

As shown in FIG. 4, the first side walls 31 include a pair of left and right lock portions 27, a plurality of lock target portions 39, a pair of left and right lower protrusions 40 (only one of them is shown in FIG. 4), and a pair of left and right upper protrusions 41 (only one of them is shown in FIG. 4). Each lock portion 27 is formed by bending a plate piece inside a slit formed in a rear end portion of the first side wall 31 toward the housing space 37. Each lock portion 27 leans inward in the left-right direction while extending forward from its rear end, and is elastically deformable in the left-right direction. When the dielectric 13 is inserted into the housing space 37 from behind and the lock portions 27 are fitted to the lock target portions 26 of the dielectric 13, the dielectric 13 is kept from coming out rearward from the housing space 37. Also, the stopper portions 28 abut against the rear end of the first outer conductor 14, and therefore, the dielectric 13 is kept from coming out forward from the housing space 37.

For example, two lock target portions 39 spaced apart from each other are provided between the elastic contact portion 36 and the lock portion 27 in the front-rear direction. Each lock target portion 39 extends through the first side wall 31 in the left-right direction (thickness direction). Lock portions 42 of the second outer conductor 15, which will be described later, can be respectively locked to the lock target portions 39.

The lower protrusions 40 and the upper protrusions 41 each correspond to a protrusion according to the present disclosure, and are provided in the front portions of the first side walls 31. In Embodiment 1, each lower protrusion 40 and each upper protrusion 41 are located between the elastic contact portion 36 and the lock target portions 39 in the front-rear direction. Each lower protrusion 40 and each upper protrusion 41 are formed by performing punching such as louver processing or hammering such that portions of the first side wall 31 protrude (bulge) outward in the left-right direction. In Embodiment 1, the lower protrusions 40 and the upper protrusions 41 have the same shape and the same size. The lower protrusions 40 and the upper protrusions 41 protrude by a protruding amount that is not larger than the thickness of each first side wall 31. Also, the protruding amount of the lower protrusions 40 and the upper protrusions 41 is smaller than the thickness of each second side wall 43 of the second outer conductor 15, which will be described later. The lower protrusions 40 are located below the upper protrusions 41. The lower protrusions 40 are located below the center of the first side walls 31 (in lower portions) in the up-down direction. The upper protrusions 41 are located above the center of the first side walls 31 (in upper portions) in the up-down direction.

The lower protrusions 40 and the upper protrusions 41 each have a first facing surface 44 as a rear end surface of the protrusion. The first facing surface 44 is, for example, a press-cut surface that is cut by being pressed in louver processing, and is formed with a slit in an outer surface of the first side wall 31. The first facing surface 44 is formed as a vertical surface extending in the up-down direction. The first facing surface 44 of the lower protrusion 40 and the first facing surface 44 of the upper protrusion 41 are aligned on the same straight line extending along the up-down direction (see the dash-dot line in FIG. 6). The first facing surfaces 44 correspond to the rear end of the tubular portion 35. When the second outer conductor 15 is attached to the first outer conductor 14, the first facing surfaces 44 face second facing surfaces 45 of the second outer conductor 15, which will be described later. The length of each of the lower protrusions 40 and the upper protrusions 41 in the up-down direction gradually increases from the front end toward the rear end (the first facing surface 44) thereof in a side view. In Embodiment 1, each first facing surface 44 has a curved surface shape in a rear view and is outlined by a straight line extending in the up-down direction and an arc curved outward in the left-right direction.

### (Second Outer Conductor 15)

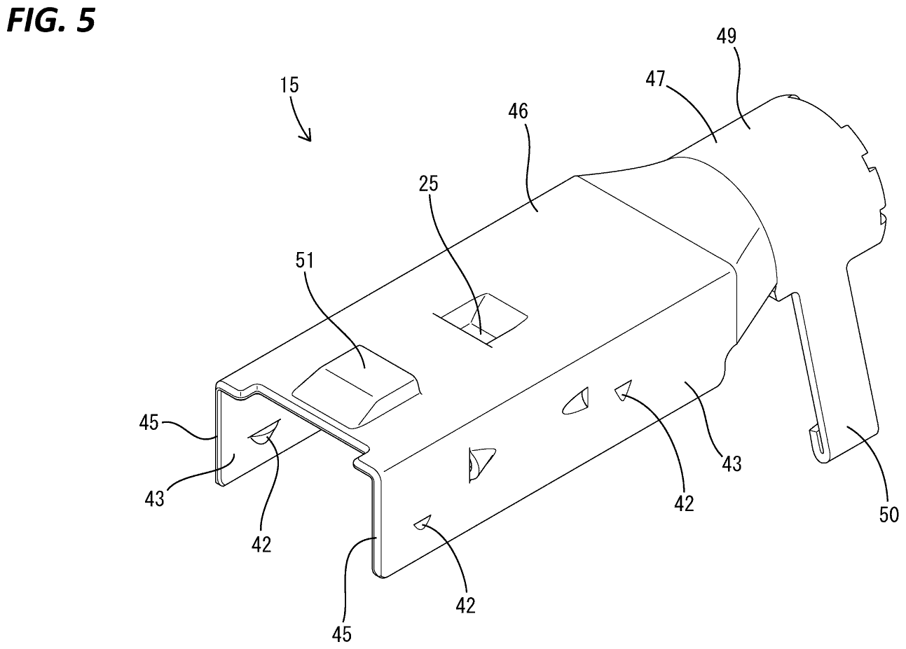

The second outer conductor 15 is made of a conductive metal and is formed by bending a metal plate through pressing or the like. The second outer conductor 15 is attached to the first outer conductor 14 from above. As shown in FIG. 5, the second outer conductor 15 has a cover wall 46, a pair of second side walls 43, and the barrel portion 47. The cover wall 46 has a flat plate shape and extends in the front-rear direction such that plate surfaces face the up-down direction. The second side walls 43 have a flat plate shape and protrude downward from both end portions of the cover wall 46 in the left-right direction such that plate surfaces face the left-right direction. The second side walls 43 and the cover wall 46 have the same length in the front-rear direction. The barrel portion 47 is coupled to the rear ends of the cover wall 46 and the second side walls 43. As shown in FIG. 2, the barrel portion 47 is crimped onto a front end portion of the shielded wire 11 and connected to the shield portion 19 folded back onto the sleeve 48. As shown in FIG. 5, the barrel portion 47 includes: a base portion 49 that is connected to the cover wall 46 and the second side walls 43; and a pair of crimping pieces 50 (only one crimping piece 50 is shown in FIG. 5) protruding downward from the base portion 49. The crimping pieces 50 are provided in such a manner as to face each other in the left-right direction. Each crimping piece 50 receives the shield portion 19 of the shielded wire 11 in an open state shown in FIG. 5, and is wound around the outer circumferential surface of the shield portion 19 after crimping. As shown in FIG. 2, the extended portion 30 is sandwiched between leading end portions of the crimping pieces 50 and the shield portion 19.

As shown in FIG. 2, when the second outer conductor is attached to the first outer conductor 14, the cover wall 46 covers the opening 38 and closes the housing space 37 from above.

As shown in FIG. 2, the upper surface lock portion 25 is formed in a center portion of the cover wall 46 by being cut and bent downward (toward the first outer conductor 14). The upper surface lock portion 25 can be locked to the upper surface lock target portion 24 of the second dielectric 22. Also, as shown in FIG. 5, a housing lock portion 51 is formed in a front end portion of the cover wall 46. The housing lock portion 51 is located forward of the upper surface lock portion 25. The housing lock portion 51 is formed by making a portion of the cover wall 46 bulge upward. The rear end of the housing lock portion 51 is locked to a lance of the housing (not shown). Thus, the shielded terminal 10 is held by the housing.

As shown in FIG. 1, when the second outer conductor 15 is attached to the first outer conductor 14, the second side walls 43 cover the first side walls 31 from the outside of the first outer conductor 14 in the left-right direction. As shown in FIG. 5, each second side wall 43 has a plurality of lock portions 42. Each lock portion 42 protrudes to the inside of the second outer conductor 15 in the left-right direction. Each lock portion 42 is formed by making a portion of the second side wall 43 bulge inward in the left-right direction. The lock portions 42 are spaced apart from each other in the front-rear direction so as to correspond to the lock target portions 39. The lock portions 42 can be locked to the lock target portions 39 of the first outer conductor 14.

The second side walls 43 each have the second facing surface 45 as a front end surface. The second facing surface 45 is a vertical surface extending in the up-down direction. The second facing surfaces 45 constitute the front end surface of the second outer conductor 15. When the second outer conductor 15 is attached to the first outer conductor 14, the second facing surfaces 45 face the first facing surfaces 44.

### (Effects of Shielded Terminal 10)

Next, an example of a procedure for assembling the shielded terminal 10 will be described.

The two inner conductors 12 are connected to the core wires exposed at the front end portions of the coated wires 17 to connect the inner conductors 12 and the shielded wire 11. The inner conductors 12 are inserted into the second dielectric 22. Subsequently, the second dielectric 22 is covered by the first dielectric 21 to sandwich and hold the inner conductors 12 between the first dielectric 21 and the second dielectric 22 (see FIG. 3).

The dielectric 13 holding the inner conductors 12 is inserted into the housing space 37 from the rear side of the first outer conductor 14. The dielectric 13 is moved forward along upper surfaces of the extended portion 30 and the bottom wall 29. When the dielectric 13 is attached to the first outer conductor 14, the lock portions 27 fit into the lock target portions 26, and the stopper portions 28 abut against the rear end of the first outer conductor 14. At this time, the tabs 16 of the inner conductors 12 protrude to the inside of the tubular portion 35.

Subsequently, the second facing surfaces 45 of the second outer conductor 15 are placed above the first facing surfaces 44 of the upper protrusions 41. Then, the second outer conductor 15 is moved downward using the first facing surfaces 44 of the upper protrusions 41 as guides (reference). In the process for attaching the second outer conductor 15, the second facing surfaces 45 can be moved along the first facing surfaces 44 (see the dash-dot line in FIG. 6). Thus, the position of the front end of the second outer conductor 15 can be determined. Therefore, the second outer conductor 15 can be easily attached to the first outer conductor 14. Also, in the process for attaching the second outer conductor 15, the lock portions 42 come into contact with the left and right outer surfaces of the first side walls 31, and the second side walls 43 spread outward in the left-right direction.

When the second outer conductor 15 is attached to the first outer conductor 14, the opening 38 is covered by the cover wall 46. At this time, the barrel portion 47 covers the shield portion 19 of the shielded wire 11 from above. The second side walls 43 elastically return to their original positions and the lock portions 42 are locked to the lock target portions 39, and thus the second outer conductor 15 is retained in the state of being kept from coming off from the first outer conductor 14.

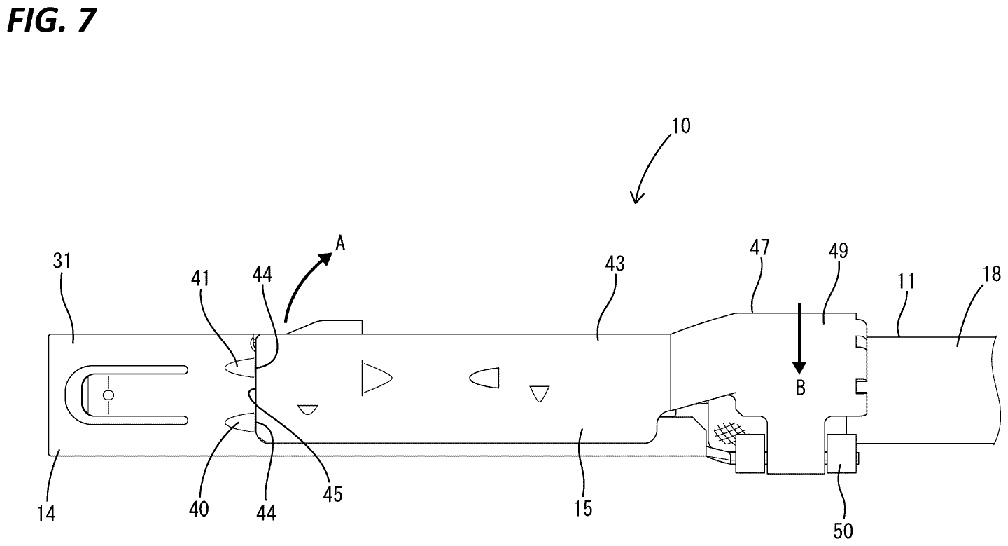

Thereafter, the barrel portion 47 is crimped onto the shield portion 19 of the shielded wire 11. Specifically, the barrel portion 47 is disposed between a lower die and an upper die (not shown) and pressed by the upper die that is lowered in the direction of an arrow B (see FIG. 7) relative to the lower die, whereby the barrel portion 47 is crimped in such a manner as to be wound around the shield portion 19.

During the above-described process for crimping the barrel portion 47, a force acts on a front end portion of the cover wall 46 in such a manner that the front end portion rotates about the barrel portion 47 to be raised relative to the first outer conductor 14 (see arrow A in FIG. 7). In particular, the lower protrusions 40 are located in the lower portions of the first side walls 31 and the second facing surfaces 45 are at the position farthest from the barrel portion 47 in the second outer conductor 15. Therefore, the force that causes the rotation of the second outer conductor 15 acts significantly on the first facing surfaces 44, which come into contact with the second facing surfaces 45. Accordingly, due to the second facing surfaces 45 of the second outer conductor 15 coming into contact with the first facing surfaces 44 of the lower protrusions 40, it is possible to effectively prevent the second outer conductor 15 from being displaced in such a manner as to be raised relative to the first outer conductor 14. Moreover, the second facing surfaces 45 are the front end surfaces of the second side walls 43 and are not formed by cutting the second side walls 43, and therefore, the shield performance can be maintained.

Note that the lock portions 42 can be fitted and locked to the lock target portions 39, and accordingly, displacement of the second outer conductor 15 from the first outer conductor 14 can be suppressed. However, even after the lock portions 42 are fitted to the lock target portions 39, there are gaps between the lock portions 42 and the lock target portions 39. Therefore, there is a concern that the second outer conductor 15 may be displaced from the first outer conductor 14 due to the gaps. In this respect, in Embodiment 1, gaps between the first facing surfaces 44 and the second facing surfaces 45 facing each other are smaller than those gaps. Also, the second facing surfaces 45 come into contact with the first facing surfaces 44 at positions close to the positions at which the lock portions 42 are locked to the lock target portions 39. Due to the second facing surfaces 45 coming into contact with the first facing surfaces 44, it is possible to prevent the second outer conductor 15 from being displaced in such a manner as to be raised relative to the first outer conductor 14 as described above, and additionally, it is possible to avoid abutment of the lock portions 42 against the lock target portions 39, and thus, it is possible to prevent application of a load to the portions where the lock portions 42 are locked to the lock target portions 39. In particular, in Embodiment 1, the first facing surfaces 44 and the second facing surfaces 45 are vertical surfaces extending in the up-down direction. Therefore, it is possible to reliably prevent the front end portion of the cover wall 46 from being displaced in such a manner as to be raised relative to the first outer conductor 14.

### OTHER EMBODIMENTS OF THE PRESENT DISCLOSURE

The disclosed embodiment is an example in all aspects and should not be considered as limiting the present invention.

In Embodiment 1 described above, the first facing surfaces are the rear end surfaces of the lower protrusions and the upper protrusions. In another embodiment, steps may be formed in the first side walls, instead of the lower protrusions, and rear end surfaces of the steps may be used as the first facing surfaces.

In Embodiment 1 described above, the lower protrusions and the upper protrusions have the same shape. In another embodiment, the lower protrusions and the upper protrusions may have different shapes.

In Embodiment 1 described above, the protruding amount of the protrusions is smaller than the thickness of each second side wall. The protruding amount of the protrusions may be larger than the thickness of each second side wall.

In Embodiment 1 described above, the protrusions are formed through punching such as louver processing or hammering. The protrusions may also be formed by being cut and bent.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shielded terminal comprising:
an inner conductor connected to a front end portion of a shielded wire.
a dielectric in which the inner conductor is housed.
a first outer conductor that receives the dielectric; and
a second outer conductor attached to the first outer conductor,
wherein the first outer conductor includes:
a pair of first side walls facing each other in a left-right direction; and
an opening formed between upper ends of the pair of first side walls, the second outer conductor includes:
a cover wall covering the opening from above.
a pair of second side walls facing each other in the left-right direction; and
a barrel portion coupled to a rear end portion of the cover wall,
the barrel portion is connected to a shield portion of the shielded wire by crimping,
the pair of first side walls each have a first facing surface facing rearward, and
the pair of second side walls protrude downward from the cover wall and each have a second facing surface as a front end surface that faces the first facing surface.

2. The shielded terminal according to claim 1,
wherein the pair of first side walls each have a protrusion protruding outward in the left-right direction, and
the first facing surface is a rear end surface of the protrusion.

3. The shielded terminal according to claim 2,
wherein the protrusion is located in a lower portion of each of the pair of first side walls.

4. The shielded terminal according to claim 3,
wherein the protrusion includes an upper protrusion located in an upper portion of each of the pair of first side walls, in addition to a lower protrusion located in the lower portion, a rear end surface of the upper protrusion also constitutes the first facing surface that faces the second facing surface, and the first facing surfaces of the upper protrusion and the protrusion are aligned on the same straight line extending along an up-down direction.

5. The shielded terminal according to claim 1,
wherein both the first facing surface and the second facing surface are vertical surfaces extending in an up-down direction.
